(19) United States
(12) Patent Application Publication
(10) Pub. No.: US 2013/0227085 A1
(43) Pub. Date: Aug. 29, 2013

(54) TERMINAL AND METHOD FOR USING CLOUD SERVICES

(71) Applicant: Pantech Co., Ltd., (US)

(72) Inventors: Sung Chul CHOI, Seoul (KR); Jeong Muk Kang, Seoul (KR)

(73) Assignee: Pantech Co., Ltd., Seoul (KR)

(21) Appl. No.: 13/769,603

(22) Filed: Feb. 18, 2013

(30) Foreign Application Priority Data
Feb. 24, 2012 (KR) 10-2012-0019101

(51) Int. Cl. H04L 29/08

(52) U.S. Cl. CPC H04L 67/02
USPC 709/219

(57) ABSTRACT

A method for synchronizing a cloud service including identifying a cloud application corresponding to a cloud file stored in a first cloud server; modifying the cloud file using the identified cloud application; and updating a corresponding interlinked file stored in a first terminal to reflect the modification of the cloud file. A terminal to synchronize a cloud service including a cloud application to access a cloud file stored in a first cloud server; and a cloud managing unit to identify the cloud application to be synchronized with the cloud file, and when the cloud file is modified, to update a corresponding interlinked file stored in the first terminal to reflect the modification of the cloud file.

### CROSS-REFERENCE TO RELATED APPLICATION

This application claims priority and the benefit under 35 U.S.C. §119(a) of Korean Patent Application No. 10-2012-0019101, filed on Feb. 24, 2012, which is hereby incorporated herein by reference for all purposes.

### BACKGROUND

1. Field

Exemplary embodiments of the present invention relate to a terminal and a method for managing the use of cloud services.

2. Discussion of the Background

Cloud computing may refer to a storing of a software program and/or data in an external computer server or a computing device, which may not be stored in a user terminal, such is as a personal computer (PC) or a smart phone operated by a user, to be accessed by the user terminal through the Internet. The accessed software program or data stored in the external computer server may be used by the user terminal.

A web enabled mail service or Internet mail may be an example of a basic model of the cloud computing. The web mail may be read using the Internet, but the corresponding data, such as a received mail that may be read at the user terminal, is not stored in the user terminal but stored in a web mail server, namely a server of a web mail service provider.

A user may be provided with one or more computing resources through the Internet at various places without the use of a dedicated user terminal by using the cloud computing. The computing resources may be generally managed by a separate resource provider, such as a large-capacity data center. The computing resources may include hardware resources, such as a central processing unit (CPU) capability, memory and storage, or software resources, such as development platforms and application programs. A service provided by a resource provider to allow the computing capability or the computing resource of the external server to be used at a terminal via a network may be referred to as a cloud service.

The cloud service may be useful in that a user may use the cloud service if the user is able to gain access to a network without having a dedicated device with a specific application program or data stored therein. More particularly, when using the cloud service, a user has no need to purchase a high-performance computer or expensive software if an Internet connection is allowed. Therefore, various cloud services provided as portable PCs, such as smart phones and tablet PCs, may be propagated along with the recent development of wireless Internet, such as Wireless Fidelity (Wi-Fi), and 3^{rd} generation (3G) network.

However, even when various cloud services may be provided, such cloud services is may be provided in an independent manner, or siloed. Therefore, in many cases, an application to interlink two or more cloud services may be installed at the user terminal. Accordingly, in order to use various multimedia data and backup data that may be offered through various cloud services, multiple applications to interlink the various cloud services may be used to synchronize such data at the user terminal.

Further, as various cloud services may be used in the user terminal, there may be some difficulties in management, such as duplicated storage, confused storage locations or the like. In addition, even when the terminal may be synchronized with a cloud service, the control applied to a certain cloud service may influence on synchronization with another cloud service. Accordingly, as the quantity of used cloud services increases, the difficulties in the management of cloud services may also increase.

In this regard, a method capable of avoiding duplicated storage of a file in a cloud service having a limited storage space and allowing a user to use and manage various cloud services in a terminal more efficiently may be needed.

### SUMMARY

Exemplary embodiments of the present invention provide a terminal and a method for managing the use of cloud services.

Additional features of the invention will be set forth in the description which follows, and in part will be apparent from the description, or may be learned by practice of the invention.

Exemplary embodiments of the present invention provide a method for synchronizing a cloud service including identifying a cloud application corresponding to a cloud file stored in a first cloud server; modifying the cloud file using the identified cloud application; and updating a corresponding interlinked file stored in a first terminal to reflect the modification of the cloud file.

Exemplary embodiments of the present invention provide a terminal to synchronize a cloud service including a cloud application to access a cloud file stored in a first cloud server; and a cloud managing unit to identify the cloud application to be synchronized with the cloud file, and when the cloud file is modified, to update a corresponding interlinked file stored in the first terminal to reflect the modification of the cloud file.

Exemplary embodiments of the present invention provide a method for synchronizing a cloud service including identifying a cloud application corresponding to a cloud file stored in a cloud server; updating an interlinked file stored in a first terminal corresponding to the cloud file; and updating the cloud file using the identified cloud application for reflecting the modification of the interlinked file.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a block diagram illustrating a configuration of a terminal capable of using a cloud service according to an exemplary embodiment of the present invention.

FIG. 2 is a block diagram illustrating an integrated management of cloud applications performed by a cloud managing unit according to an exemplary embodiment of the present invention.

FIG. 3 is a schematic diagram illustrating a cloud application database according to an exemplary embodiment of the present invention.

FIG. 4 is a schematic diagram illustrating a file database according to an exemplary embodiment of the present invention.

FIG. 5 is a diagram illustrating management of cloud services using a cloud managing application according to an exemplary embodiment of the present invention.

FIG. 6 illustrates processing updates to a file stored in a cloud system according to an exemplary embodiment of the present invention.

FIG. 7 is a flowchart illustrating a method for shifting a storage server of a cloud file according to an exemplary embodiment of the present invention.

FIG. 8 is a diagram illustrating a file management process according to an exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that when an element is referred to as being “connected to” another element, it can be directly connected to the other element, or intervening elements may be present. Throughout the drawings and the detailed description, unless otherwise described, the same drawing reference numerals are understood to refer to the same elements, features, and structures. The relative size and depiction of these elements may be exaggerated for clarity.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc.

does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

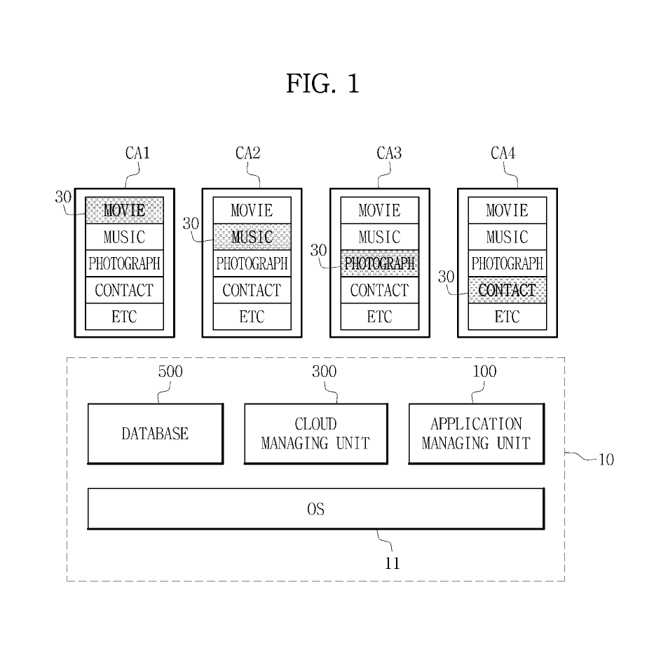

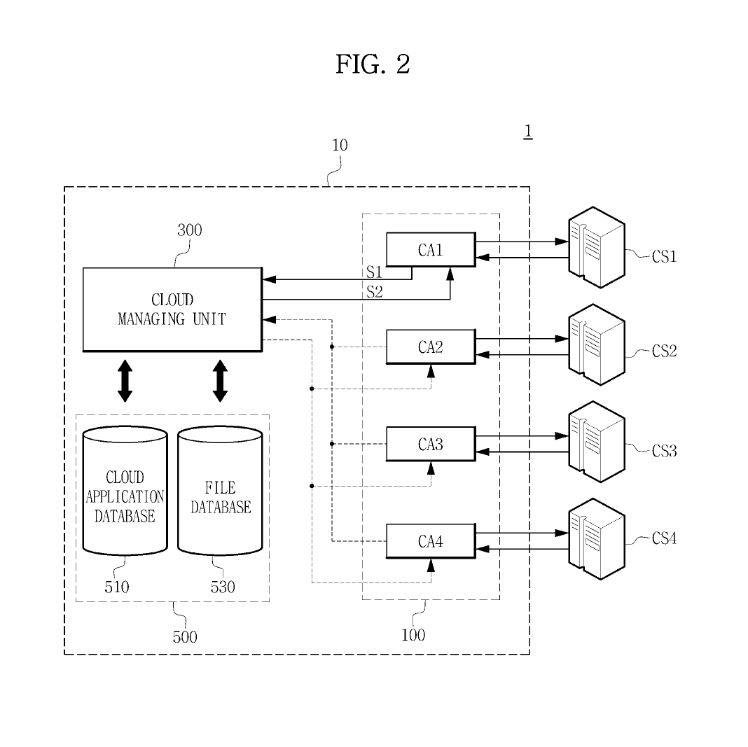

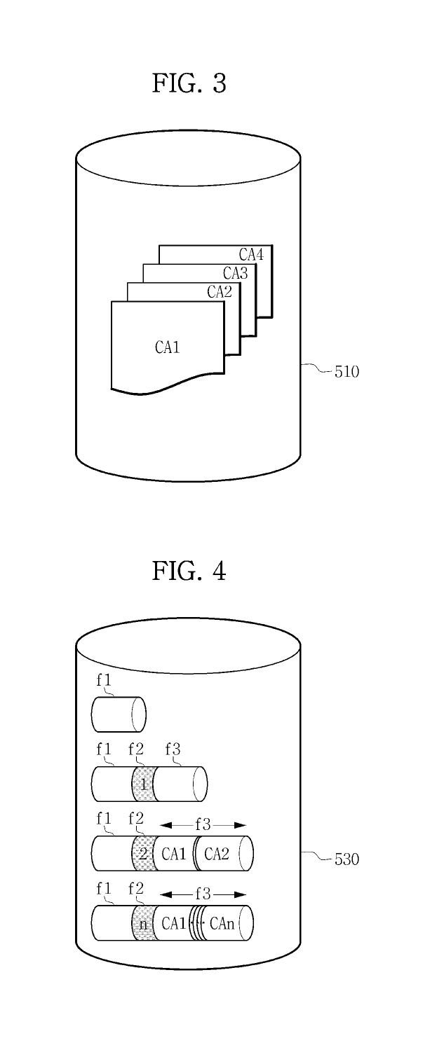

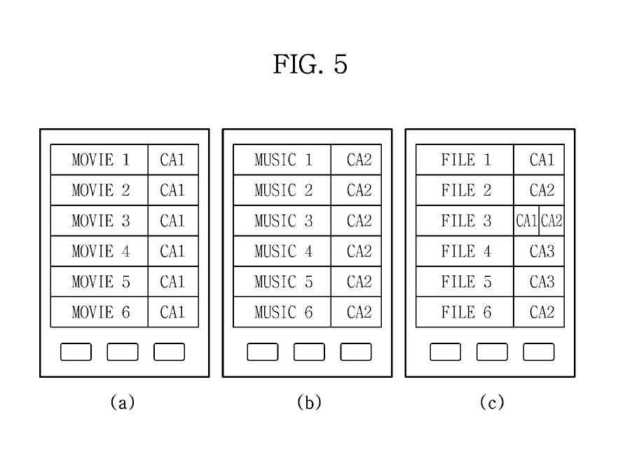

FIG. 1 is a block diagram illustrating a configuration of a terminal capable of using a cloud service according to an exemplary embodiment of the present invention. FIG. 2 is a block diagram illustrating an integrated management of cloud applications performed by a cloud managing unit according to an exemplary embodiment of the present invention. FIG. 3 is a schematic diagram illustrating a cloud application database according to an exemplary embodiment of the present invention. FIG. 4 is a schematic diagram illustrating a file database according to an exemplary embodiment of the present invention. FIG. 5 is a diagram illustrating management of cloud services using a cloud managing application according to an exemplary embodiment of the present invention.

Referring to FIG. 1, a terminal 10 includes an application managing unit 100, a cloud managing unit 300 and a database 500, which may operate with respect to an operating system (OS) platform 11 used by the terminal 10.

The terminal 10 may include various types of mobile computers that may be capable of accessing the Internet, such as a smart phone, a tablet computer, a net book, a personal digital assistant (PDA), a portable media player (PMP) or the like. Further, the terminal 10 may comprehensively include a driver program, which may control one or more software programs installed or stored in the terminal 10. In addition, the OS may include various types of OSes that may be loadable on a mobile computer, such as Android® OS, iOS®, Window Mobile® OS, Bada® OS, Symbian® OS, Blackberry® OS or the like.

Referring to FIG. 1, the terminal 10 uses a plurality of cloud applications. Each cloud application may correspond to a corresponding cloud server of a service provider and may be operated to access and or manage cloud files stored in its corresponding cloud server. The terminal 10 may register at least one of a first cloud application CA1, a second cloud application CA2, a third cloud application CA3, and a fourth cloud application CA4 among the plurality of cloud applications and may integrally manage one or more registered cloud applications.

One or more cloud applications may be designated to access or execute a cloud file stored in a specific cloud server by being interlinked with that respective cloud server. More specifically, the first cloud application CA1 may be designated to operate a cloud movie file, which may be accessed by executing a corresponding local movie file stored in the terminal 10. Accordingly, a user may access the cloud movie file by executing the corresponding interlinked file with the corresponding cloud application. In an example, the terminal may store at least a portion of a copy of the cloud file or information associated with the cloud file as a local file or an interlinked file.

A user may check and manage various cloud files interlinked with the registered cloud applications, including the first cloud application CA1, the second cloud application CA2, the third cloud application CA3, and the fourth cloud application CA4, through a single terminal 10. Although the terminal 10 is illustrated as registering and managing four cloud applications, the first cloud application CA1, the second cloud application CA2, the third cloud application CA3, and the fourth cloud application CA4, the terminal 10 may register and manage at least one cloud application without being limited thereto; for example, the terminal 10 may register fewer than 4 applications to be managed, or more than 4 applications to be managed, e.g., 1, 2, 3, 4, 5, 8, 11, 20 applications to be managed.

The application managing unit 100 may support execution of the cloud applications on the terminal 10 and may collect information associated with the cloud applications. The application managing unit 100 may refer to an operational component of the platform 11. The application managing unit 100 may manage some or all applications, including the cloud applications executed at the terminal 10, and may extract information associated with an application executed at the terminal 10.

The cloud managing unit 300 may register a part of cloud applications installed at the terminal 10 in a management list and integrally manages at least one of the registered cloud applications, including the first cloud application CA1, the second cloud application CA2, the third cloud application CA3, and the fourth cloud application CA4. The cloud managing unit 300 may be an operation component of the platform 11, which may take control the cloud applications, among other applications, and the corresponding cloud files.

The cloud managing unit 300 may manage cloud files by designating a synchronization region 30, which may allow synchronization with the terminal 10, and a limited synchronization region, where synchronization may be limited. The cloud managing unit 300 may designate a synchronization region 30 and/or a limited synchronization region for each of the cloud applications, including the first cloud application CA1, the second cloud application CA2, the third cloud application CA3, and the fourth cloud application CA4. Further, each of the first cloud application CA1, the second cloud application CA2, the third cloud application CA3, and the fourth cloud application CA4 may recognize cloud files designated by the cloud managing unit 300 to manage the designated cloud files.

The cloud managing unit 300 may designate at least one of the first cloud application CA1, the second cloud application CA2, the third cloud application CA3, and the fourth cloud application CA4 to be synchronized by selecting one or more cloud applications corresponding to each cloud file. Further, the cloud managing unit 300 may also designate at least one of the first cloud application CA1, the second cloud application CA2, the third application CA3, and the fourth cloud application CA4 to be synchronized by classifying one or more cloud applications according to specific categories a cloud file may fall into (e.g., movies, music, and contact). When a plurality of cloud servers are interlinked with at least one of the first cloud application CA1, the second cloud application CA2, the third cloud application CA3, and the fourth cloud application CA4, the respective cloud servers may be used as dedicated servers corresponding to specific categories of cloud files.

For example, as shown in FIG. 1, the first cloud application CA1 may synchronize and manage movie content, the second cloud application CA2 may synchronize and manage music content, the third cloud application CA3 may synchronize and manage photograph or image content, and the fourth cloud application CA4 may synchronize and manage contact information content. More specifically, one or more cloud applications may synchronize and manage files of a specific type (i.e., movie, music, photograph, and the like).

When a user installs a cloud application at the terminal 10 but uses the cloud application without registering the cloud application to the cloud managing unit 300, the cloud application may be recognized like a general application by the OS platform 11 of the terminal 10. Accordingly, the unregistered cloud application may freely access some or all files and database of the terminal 10. Therefore, the cloud application that may not be registered to the cloud managing unit 300 may be used in the same way as a conventional cloud service.

The cloud managing unit 300 may use a cloud managing application interlinked with the cloud managing unit 300 in order to integrally manage at least one of the first cloud application CA1, the second cloud application CA2, the third cloud application CA3, and the fourth cloud application CA4. When using the cloud managing application, cloud files synchronized with at least one of the first cloud application CA1, the second cloud application CA2, the third cloud application CA3, and the fourth cloud application CA4 may be checked and managed through a single integrated application.

The cloud managing unit 300 receives information associated with at least one of the first cloud application CA1, the second cloud application CA2, the third cloud application CA3, and the fourth cloud application CA4 from the application managing unit 100, and transfers the received information to the database 500.

The database 500 may be a database component of the OS platform 11. A cloud application installed or stored in the terminal 10 may access one or more contents, and a software block that may be stored in the database 500. The software block may be used to manage the database 500.

Some or all applications installed or stored in the terminal 10 may be able to use or access some or all of local the files provided by the OS platform 11 without limitation. Therefore, for the compatibility of a local application, which may not be a cloud application, an extended region may be formed while maintaining an existing database, and information associated with a corresponding cloud service may be stored in the extended region. The database 500 will be described below in more detail with reference to FIG. 3 and FIG. 4.

Referring to FIG. 2, the cloud system 1 includes a terminal 10 and multiple cloud services that may be accessed by the terminal 10, including a first cloud service CS1, a second cloud service CS2, a third cloud service CS3, and a fourth cloud service CS4. If a first cloud application CA1, which may be interlinked with a first cloud server CS1 to provide access to a cloud service for the terminal 10, is executed, the cloud managing unit 300 may register the first cloud application CA1 in the management list. More specifically, the first cloud application CA1 may be registered by using identification information of the first cloud application CA1, which may be collected by the application managing unit 100 (S1).

If the first cloud application CA1 is executed on terminal 10, identification information of the first cloud application CA1 may be collected and the cloud managing unit 300 may automatically add the first cloud application CA1 in the management list. Further, a user may manually add the first cloud application CA1 in the management list by selecting the first cloud application CA1 to be added in the management list.

If the first cloud application CA1 is registered to the cloud managing unit 300, the application managing unit 100 may extract the information associated with the first cloud application CA1 and may notify the cloud managing unit 300 of the information. The notified cloud managing unit 300 may store the information associated with the first cloud application CA1 in the database 500. The information associated with the first cloud application CA1 may include the identification information and execution information. The information associated with the first cloud application CA1 will be described below in more detail with reference to FIG. 3.

In addition, if the first cloud application CA1 is registered in the management list, management information associated with cloud files managed by the first cloud application CA1 may be stored in the database 500. Management information associated with the cloud files will be described below in more detail with reference to FIG. 4.

Similar to the registration of the first cloud application CA1, if at least one of the second cloud application CA2, the third cloud application CA3, and the fourth cloud application are executed, at least one of the second cloud application CA2, the third cloud application CA3, and the fourth cloud application CA4 may be automatically registered in the management list or according to a selection by the user. The application managing unit 100 may extract the information associated with at least one of the second cloud application CA2, the third cloud application CA3, and the fourth cloud application CA4, and may store the information in the database 500.

Similarly, if at least one of the second cloud application CA2, the third cloud application CA3, and the fourth cloud application CA4 are registered in the management list, management information associated with the cloud files managed by at least one of the second cloud application CA2, the third cloud application CA3, and the fourth cloud application CA4 may be stored in the database 500.

Further, the cloud managing unit 300 may be operated to designate and/or manage a cloud application to be synchronized with one or more cloud files. One or more of the first cloud application CA1, the second cloud application CA2, the third cloud application CA3, and the fourth cloud application CA4 may recognize a cloud file where its synchronization may be designated by the cloud managing unit 300, and the cloud managing unit 300 may operate to manage the designated cloud file (S2). The cloud file designated by the cloud managing unit 300 may respectively be stored in at least one of first the cloud server CS1, the second cloud server

CS2, the third cloud server CS3, and the fourth cloud server CS4, which may be interlinked with at least one of the first cloud application CA1, the second cloud application CA2, the third cloud application CA3, and the fourth cloud application CA4.

The cloud managing unit 300 may manage a cloud application to be synchronized with one or more cloud files stored in a cloud server using the database 500, which may store corresponding information associated to the cloud file. More specifically, the database 500 may include information associated with the cloud file, such as a corresponding local file or an interlinked file, a designated cloud application, and a corresponding cloud server storing the cloud file.

For this, the database 500 may include a cloud application database 510 and a file database 530. The cloud application database 510 may store information associated with the first cloud application CA1, the second cloud application CA2, the third cloud application CA3, and the fourth cloud application CA4. The file database 530 may store information associated with interlinked files that may be stored in the terminal 10 and corresponding cloud files stored in at least one of the first cloud server CS1, the second cloud server CS2, the third cloud server CS3, and the fourth cloud server CS4. The cloud application database 510 and the file database 530 may include a specific data of a certain type in each data field, in which the data field may refer to a minimal unit of a storage region of the file.

Referring to FIG. 3, the cloud application database 510 may store information associated with at least one of the first cloud application CA1, the second cloud application CA2, the third cloud application CA3, and the fourth cloud application CA4 according to one or more cloud applications so that the cloud managing unit 300 may control cloud applications individually.

When the cloud managing unit 300 registers two cloud applications in the management list, two corresponding information fields may be generated. When a new cloud application is registered, an additional information field may be added. Referring to FIG. 3, since the cloud managing unit 300 registers the first cloud application CA1, the second cloud application CA2, the third cloud application CA3, and the fourth cloud application CA4, four corresponding information fields may be generated.

If at least one of the first cloud application CA1, the second cloud application CA2, the third cloud application CA3, and the fourth cloud application CA4 are registered in the management list, at least one of the first cloud application CA1, the second cloud application CA2, the third cloud application CA3, and the fourth cloud application CA4 may be controlled by the cloud managing unit 300, which may allow corresponding cloud files to be selectively synchronized and stored.

Each information field of the cloud application database 510 may store information associated with a corresponding cloud application. For example, each information field may store at least one of identification information, and execution information. Identification information may include, without limitation, at least one of an identification name, an identification number or code, and an icon or image associated with the corresponding cloud application. Execution information may include, without limitation, at least one of an execution state, a service list, a minimal execution component, an execution option list, an access time, and a command list. Further, the execution information may provide relationship information between an interlinked file, a corresponding cloud file and a corresponding cloud application.

The identification name, identification number or code, and the identification icon or image associated with the cloud application may refer to information representing the cloud application. The icon may refer to an image or text symbolizing the cloud application. The cloud managing unit 300 may manage the management list based on the identification information of the cloud application.

The execution state of the cloud application may refer to information representing whether the cloud application is in execution. The service list of the cloud application may refer to information associated with a category of the cloud application to which synchronization may be set.

The minimal execution component may refer to execution information of the cloud application, which may be stored to execute a minimal execution component while being interlinked with the cloud application when the cloud managing unit 300 uses the cloud managing application. For example, the minimal execution component may be correspond to an Activity in Android® platform, a Page in Windows® platform, View Controller in iOS® platform, or the like.

The execution option list of the cloud application may refer to information representing an option which may be added when the minimal execution component may be executed. The access time of the cloud application may refer to information representing time during which the cloud application may be executed. The command list of the cloud application may refer to extendability information associated with extendability of the respective cloud application to other cloud applications. The extendability information may represent a command for interlinking the respective cloud application with another cloud application. When there is a cloud service embedded in the terminal 10, for example, when the extendability information may represent a command for interlinking the respective cloud application with a main cloud server.

Referring to FIG. 4, the file database 530 may store management information of local files or interlinked files stored in the terminal 10 and information of cloud files stored in at least one of the first cloud server CS1, the second cloud server CS2, the third cloud server CS3, and the fourth cloud server CS4. When individual databases storing interlinked files of the terminal 10 and/or cloud files interlinked with a corresponding cloud service, a first existing data field f1 associated with existing cloud files may be maintained, and a second extended field f2, and a third extended field f3 may be added.

More specifically, the existing common database region f1 may be accessible and used by some or all applications. When one or more applications are registered in a bundle according a category selected by the user, or when a user selects a cloud file to register in a cloud application to be synchronized, the corresponding cloud file may add a count field f2 to store a number of cloud applications associated with the interlinked file to be synchronized. More specifically, the count field f2 may correspond to a number of cloud applications that may be synchronized or updated to reflect a change or an update that may be made on the corresponding cloud file. The cloud managing unit 300 may manage whether one or more cloud files may be synchronized with the corresponding cloud application by using management information. The management information may include, without limitation, at least one of a name, a type, a size, a time, and a thumbnail image. The management information may be stored in the existing data field f1 of the file.

The cloud file may be synchronized with the number of cloud applications corresponding to the number stored in the count field f2. If the count is ‘0’, the respective file may not been synchronized with any cloud and may not be managed by the cloud managing unit 300. Accordingly, when the count reflects a value of ‘0’, the cloud file may not be recognized by a cloud application registered in the terminal 10. A cloud application that is not downloaded and registered with the cloud managing unit 300 and an application other than a cloud application may be operated in a conventional manner.

In addition, a reference field f3, which may store information associated with cloud applications corresponding to number stored in count field f2, is added. The reference field f3 may refer to a reference value identifying which cloud application may be synchronized with the respective file. For example, the reference field f3 may include at least one of address information, file storage location information, category information and backup information of the cloud application database 510, which may store information associated with the cloud application to be synchronized with the cloud file.

The file database 530 may store address information of the cloud application database 510 and refer to a cloud application database 510 of the corresponding address when applicable. The file storage location information may refer to information indicating whether the interlinked file is present only in an interlinked cloud server or is stored in both the cloud server and the terminal 10. Further, the category information may refer to information indicating whether the corresponding file conforms to a category setting or an individual setting.

When the interlinked file is deleted from the terminal 10 but a corresponding cloud file remains in the synchronized cloud server, backup information for displaying that the cloud file may be present in the cloud server. The cloud managing unit 300 may manage the cloud file by using the backup information and allow the cloud file to be downloaded again to the terminal 10. Therefore, the capacity of the terminal 10 may be more efficiently managed. The backup information may include at least one of a name, a type, a size, a time and a thumbnail of the cloud file.

Referring to FIG. 5, the cloud managing unit 300 may use the cloud managing application interlinked with the cloud managing unit 300 to integrally manage the registered applications, which may include the first cloud application CA1, the second cloud application CA2, the third cloud application CA3, and the fourth cloud application CA4.

The cloud managing application may be a software program, which may provide various operations, including a managing operation to manage an interlinking setting of a cloud application. The managing operation may include at least one of an addition operation, a deletion operation, or an update operation. The managing operation may be present in various ways having a user interface (UI).

Referring to (a) of FIG. 5, a movie cloud application shows a list of movies that may be interlinked with a corresponding cloud server. For example, Movie 1, Movie, 2, Movie 3, Movie 4, Movie 5, and Movie 6 may be interlinked with the first cloud application CAL (a) of FIG. 5 may also illustrate a category of files, such as a movie category or a music category, being associated with a corresponding cloud application. Referring to (b) of FIG. 5, a music cloud application shows a list of music files that may be interlinked with a corresponding cloud server. Further, a program may be added to a cloud application to perform a management operation associated with the cloud application.

A separate setting menu may also be provided to manage one or more cloud applications. As shown in (c) of FIG. 5, a dedicated cloud management searcher may be provided to show and manage cloud interlinking information for some or all interlinked files stored in the terminal 10. Referring to (c) of FIG. 5, the dedicated cloud management searcher may show that File 1 is interlinked to the first cloud application 1 and that File 2 is interlinked to the second cloud application 2.

In addition, the corresponding cloud application or file may be executed from various local application programs stored in the terminal 10 by using the minimal execution component that may be stored in the cloud application database 510.

When using the terminal 10, a user may manage and identify a cloud application that may be interlinked with the corresponding cloud file stored in a cloud service and a local file that may be managed at the terminal 10 level. Further, the user may manage and identify the respective cloud application using the cloud managing unit 300 without duplicated file storage. More specifically, the user may manage and identify the respective cloud application at a glance through an application (e.g., applications, widgets, setting menus or the like using the cloud managing unit 300 without duplicated file storage.

In addition, since cloud services may have different storage capacities and speeds, a user may designate a cloud application interlinked with the cloud file and manage the cloud application as applicable.

Cloud services types may be increasing in number, and corresponding cloud applications for terminals to manage the increasing number of types may be developed to access the respective cloud services. However, since an increasing number of cloud applications are installed and used in a single terminal, a problem with duplicated storage and duplicated synchronization may be incurred. In addition, since limited category classification may be provided to users for various cloud services, the respective cloud services may provide a service-centric cloud service rather than a user-centric cloud service. Therefore, even when various cloud services may be provided at no cost, a user may use a limited number of cloud services due to lack of synchronization.

However, according to aspects of the invention, the user terminal-centric storage synchronization may be allowed. More specifically, the user may store and manage a category of large-capacity moving picture files in a first cloud application CA1 with a large storage capacity, and may store and manage a category of small-capacity music files at a second cloud application CA2 having a small storage capacity and a music file execution operation. In addition, since the user may set a cloud application to be synchronized with one or more files based on an arrangement pattern of files on one or more cloud services. The cloud services may be arranged to be suitable for the terminal of the user, which may be a terminal-centric cloud service.

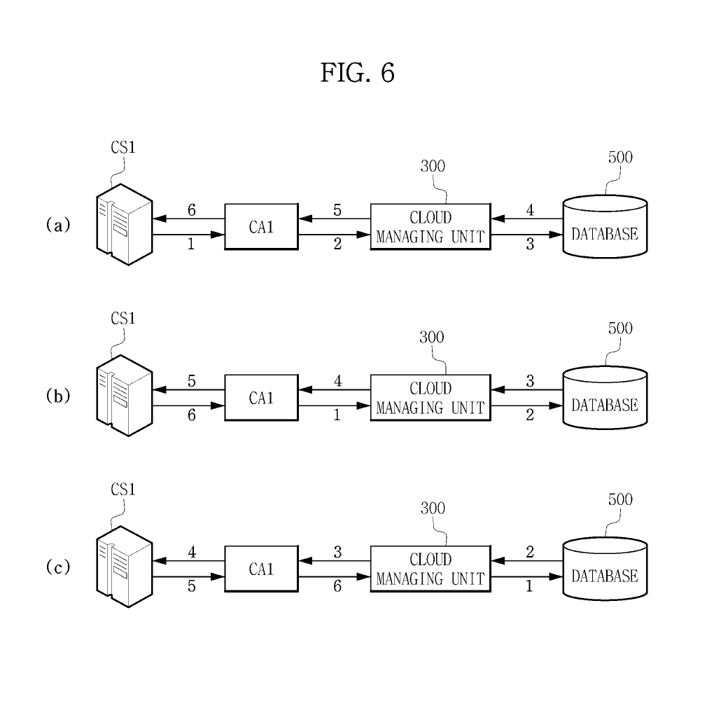

FIG. 6 illustrates processing updates to a file stored in a cloud system according to an exemplary embodiment of the present invention.

More specifically, when the terminal 10 manages the first cloud application CA1 interlinked with the first cloud server CS1 using the cloud managing unit 300, a corresponding cloud file may be updated in the first cloud server CS1, the first cloud application CA1, and the cloud managing unit 300, respectively. The update operation of the corresponding cloud file may include generating a new file, deleting an existing file, updating an existing file or the like. In addition, when the cloud server is connected to various terminals, the cloud server or an external third device may be changed.

Referring to (a) of FIG. 6, when a file update request is received from the first cloud server CS1 in operation 1, the first cloud server CS1 updates the corresponding cloud file stored thereon, and the first cloud application CA1 operates to update a corresponding cloud file stored in the CA 1. In operation 2, the CA1 relays the update request to the cloud managing unit 300, and the cloud managing unit 300 updates the corresponding file information stored therein. In operation 3, the cloud managing unit 300 relays the update request to the database 500, and the database 500 updates corresponding interlinked files and cloud files. In the following operations 4, the database 500 notifies the cloud managing unit 300 of the updating of the respective file. In operation 5, the cloud managing unit 300 notifies the first cloud application CA1 of the updating of the respective file. In operation 6, the first cloud application CA1 notifies CS1 of the updating of the respective file. However, aspects of the invention are not limited thereto, such that update operation may also include a deletion operation, and an addition operation.

When a user operates the first cloud application CA 1 directly or through the cloud managing unit 300, the first cloud application CA1 may recognize that the cloud file has been updated while synchronizing with the first cloud server CS1. When an update to the cloud file is has occurred, the cloud managing unit 300 may detect an access to the database 500 by the first cloud application CA1 and updates file information of the database 500.

In more detail, when adding an interlinked file, the corresponding file information may be added to the database 500, and when updating the interlinked file, the corresponding file information stored in the database 500 may be updated. When the interlinked file is also deleted from the terminal 10, the corresponding file information stored in the database 500 may be deleted. When the interlinked file is not deleted from the terminal 10, the corresponding file information stored in the database 500 may be updated.

If the database 500 is updated, the first cloud server CS1 may be notified that the synchronization is completed, and the file updating work may be completed.

Referring to (b) of FIG. 6, in operation 1, the cloud managing unit 300 receives a file updating request from the first cloud application CAL In response, the cloud managing unit 300 may update the corresponding file information stored therein. In operation 2, the cloud managing unit 300 relays the update request to the database 500, and the database 500 updates corresponding interlinked files and cloud files. In the following operations 3, the database 500 notifies the cloud managing unit 300 of the updating of the respective file. In operation 4, the cloud managing unit 300 notifies the first cloud application CA1 of the updating of the respective file. In operation 5, the first cloud application CA1 notifies CS1 of the updating of the respective file. In operation 6, the first cloud server CS1 relays the update request to the first cloud application CA1, and the first cloud server CS1 may update the corresponding cloud file stored therein. However, aspects of the invention are not limited thereto, such that update operation may also include a deletion operation, and an addition operation.

When a user attempts to update a file while using the first cloud application CA1, the cloud managing unit 300 may detect an access to the database 500 by the first cloud application CA1 and update the corresponding file information of the database 500.

In more detail, when adding an interlinked file, the corresponding file information may be added to the database 500, and when updating the interlinked file, the corresponding file information stored in the database 500 may be updated. When the interlinked file is also deleted from the first cloud server CS1, the corresponding file information stored in the database 500 may be deleted. When the interlinked file is not deleted from the first cloud server CS1, the corresponding file information stored in the database 500 may be updated.

The first cloud server CS1 may complete the synchronization operation requested by the first cloud application CA1, and may notify the first cloud application CA1 that the synchronization operation is completed.

Referring to (c) of FIG. 6, in operation 1 the database 500 receives a file updating request from the cloud managing unit 300. In response, the database 500 updates corresponding interlinked files and cloud files. In operation 2, the database 500 notifies the cloud managing unit 300 of the updating of the respective file. In operation 3, the cloud managing unit 300 notifies the first cloud application CA1 of the updating of the respective file. In operation 4, the first cloud application CA1 notifies CS1 of the updating of the respective file. In operation 5, the first cloud server CS1 relays the update request to the first cloud application CA1, and the first cloud server CS1 may update the corresponding cloud file stored therein. In operation 6, the first cloud application CA1 relays the update request to the cloud managing unit 300 to update the corresponding file information stored therein. However, aspects of the invention are not limited thereto, such that update operation may also include a deletion operation, and an addition operation.

Further, a user may directly update a file, or may register or release the first cloud application CA1 at the cloud managing unit 300. When a request for registering or deleting the first cloud application CA1 is received, the cloud managing unit 300 may generate or delete the corresponding file information stored in the database 500.

When a cloud file is updated or information of the corresponding cloud application is updated, the corresponding file information associated with the cloud file and the database 500 may also be updated. If the database 500 is updated, the first cloud application CA1 associated with the updated cloud file and other cloud applications may perform a synchronization operation.

When a cloud application is embedded in the terminal 10, a synchronization operation may also be performed according to a command.

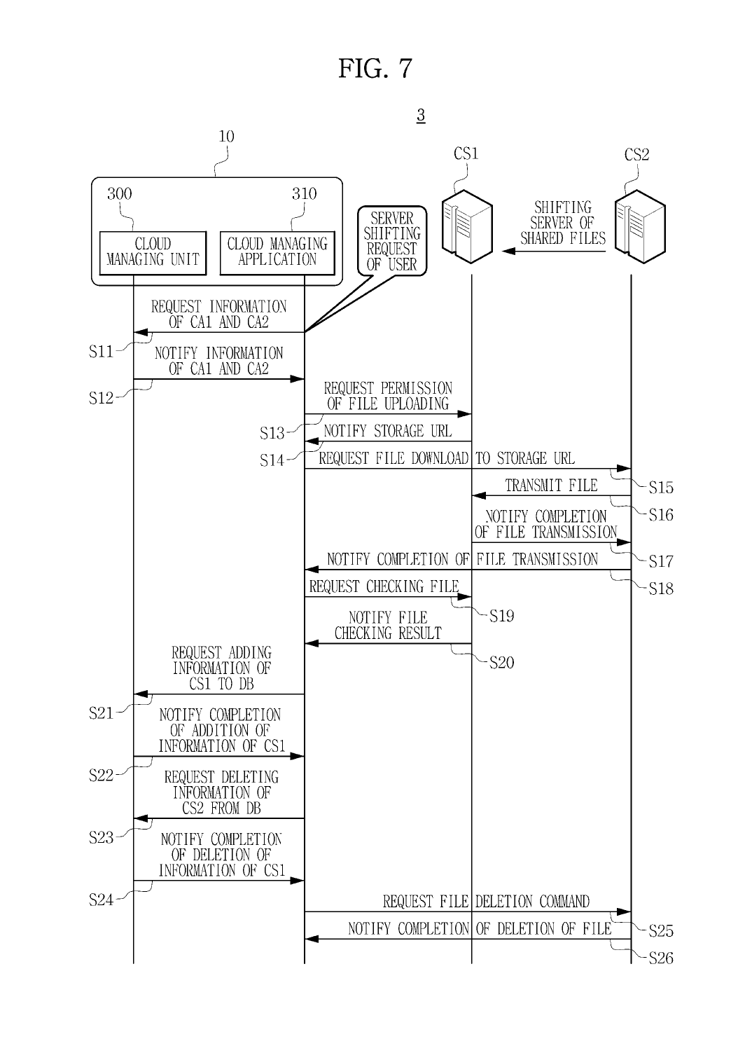

FIG. 7 is a flowchart illustrating a method for shifting a storage server of a file according to an exemplary embodiment of the present invention. The method of FIG. 7 below will be described as if performed by the terminal of FIG. 1, but is not limited as such.

Referring to FIG. 7, a cloud system 3 includes a user terminal 10 and two cloud servers, including a first cloud server CS1 and a second cloud server CS2. The cloud system 3 may support a request for shifting or changing a designated server that may be synchronized with a shared file at the terminal 10 from the second cloud server CS2 to the first cloud server CS1. More specifically, the cloud system 3 may support a request for changing a interlink relationship between the share file of terminal 10 and the second cloud server CS2 to a interlink relationship between the share file of terminal 10 and the first cloud server CS1.

Here, a first cloud application CA1 may be interlinked with the first cloud server CS1, and a second cloud application CA2 may be interlinked with the second cloud server CS2. The first cloud application CA1 and the second cloud application CA2 may be registered to and managed by the cloud managing unit 300. A cloud managing application 310 interlinked with the cloud managing unit 300 may be installed and used by the terminal 10.

In operation S11, if a user requests to shift or change the second cloud server CS2 interlinked with a shared file stored in the terminal 10 to the first cloud server CS1, the cloud managing application 310 requests for information associated to the first cloud application CA1 and the information associated with the second cloud application CA2 from the cloud managing unit 300. In operation S12, when the request is received, the cloud managing unit 300 notifies the cloud managing application 310 of the information associated with the first cloud application CA1 and the information associated with the second cloud application CA2 stored in the database 500.

In operation S13, the terminal 10 requests for permission to upload the share file stored in the terminal 10 to the first cloud server CS1 through the first cloud application CA1 by using the received information. In operation S14, the first cloud server CS1 notifies the terminal 10 of a Uniform Resource Locator (URL) corresponding to a storage location in the first cloud server CS1 for storing the share file. In operation S15, the terminal 10 requests the second cloud server CS2 to transmit the corresponding cloud file to the URL corresponding to a storage location in the first cloud server CS1.

In operation S16, the second cloud server CS2 receiving the request transmits the cloud file to the first cloud server CS1. In operation S17, if the cloud file is completely transmitted, the first cloud server CS1 notifies the completion of file transmission to the second cloud server CS2. In operation S18, the second cloud server CS2 receiving the notification of the completion of file transmission transmits or provides a notification of the completion of file transmission to the terminal 10.

In operation S19, the terminal 10 receiving the notification of the completion of file transmission requests the first cloud server CS1 to check the cloud file. In operation S20, the first cloud server CS1 receiving the checking request verifies that the cloud file is stored in the first cloud server CS1 and provides the result of the checking result to the terminal 10.

In operation S21, the cloud managing application 310 requests the cloud managing unit 300 to add the information associated with the first cloud server CS1 to the corresponding interlinked file stored in the database 500. The cloud managing unit 300 updates the interlinked file stored in the database 500, which was previously interlinked with the second cloud server CS2, to be interlinked with the first cloud server CS1, and notifies the cloud managing application 310 that the information associated with the first cloud server CS1 is added to the interlinked file.

In operation S23, the cloud managing application 310 requests the cloud managing unit 300 to delete the information associated with the second cloud server CS2 from the interlinked file stored in the database 500. The cloud managing unit 300 may update the interlinked file of the database 500 to remove information associated with the second cloud server CS2, and notifies the cloud managing application 310 that the information associated with the second cloud server CS2 is deleted from the interlinked file.

In operation S21, the request for adding the information associated with the first cloud server CS1 and the request for deleting the information associated with the second cloud server CS2 may be performed individually without specific order of processing or simultaneously. In addition, aspects of the invention are not limited thereto, such that an update operation, a deletion operation, and an addition operation may be included in the method of FIG. 7.

In operation S25, the cloud managing application 310 requests the second cloud server CS2 to delete the respective cloud file thereon. The second cloud server CS2 deletes the corresponding cloud file and notifies that the cloud file is deleted.

According aspects of the invention, a user may check a cloud server storing a cloud file corresponding to an interlinked file stored at the terminal using the cloud managing unit 300 and move the cloud file to a different cloud server or an external terminal. Since cloud application may be managed in various ways according to the aspects of the invention, the user-centric convenience may be enhanced and the storage spaces provided by various cloud services may be use more efficiently.

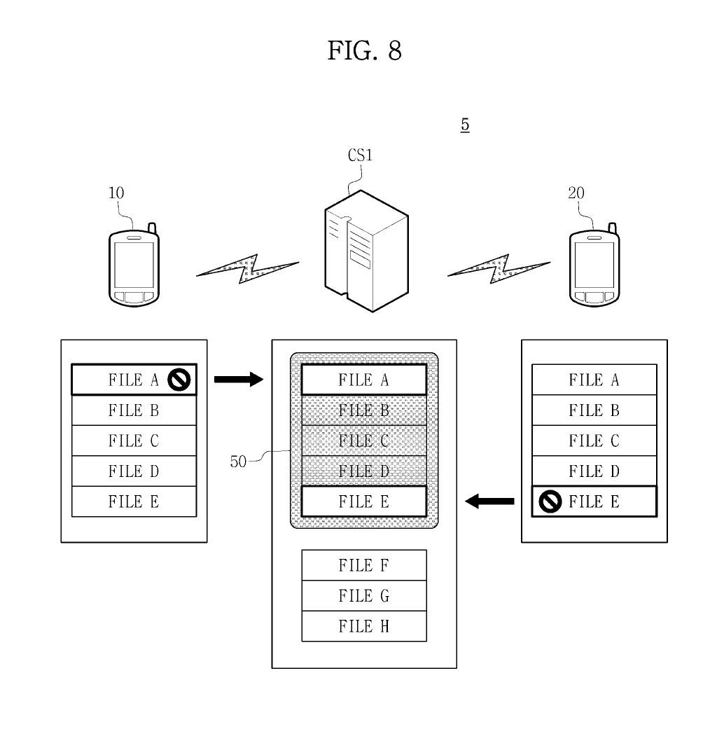

FIG. 8 is a diagram illustrating a file management process according to an exemplary embodiment of the present invention.

Referring to FIG. 8, a cloud system 5 includes a first terminal 10, a second terminal 20, and a first cloud service using the first cloud server CS1. The first terminal 10 and the second terminal 20 may be used by the same user. A user identifying process may be used for recognizing whether the terminals are used by the same user. The identifying process may include inputting a login ID and a corresponding password corresponding to the first cloud service. However, aspects of the invention are not limited to two terminals used by the same user, such that three or more terminals may be used by the same user.

When multiple terminals are used, if an interlinked file stored at one of the first terminal 10 and the second terminal 10, which may correspond to a cloud file stored in the first cloud server CS1, is updated at one of the terminals, a file synchronization system of the cloud service may synchronize the update of the interlinked file with the corresponding cloud file. Similarly, if a cloud file stored in the first cloud server CS1, a file synchronization system of the cloud service synchronizes the update of the cloud file with the corresponding interlinked files of the first terminal 10 and the second terminal 10. Further, when a user uses several terminals, data may be synchronized by applying the aspects of the invention to each terminal.

Further, according to aspects of the invention, even when a first interlinked file A is deleted from the first terminal 10, a corresponding backup file of the first interlinked file A may be stored as backup information in the database 500 of the first terminal 10. Accordingly, a cloud file A corresponding to the first interlinked file A may be managed through the cloud managing unit 300 of the first terminal 10. In addition, by manipulating the cloud managing unit 300, the cloud file A may still be stored in a synchronization region 50 of the first cloud server CS1 without being deleted. Therefore, the corresponding first interlinked file A stored in the second terminal 20 may not be influenced by the deletion of the first interlinked file A from the first terminal 10.

Similarly, when a second interlinked file E is deleted from the second terminal 20, a corresponding backup file of the second interlinked file E may remain as backup information in the database 500 of the second terminal 20. Accordingly, a cloud file E corresponding to the second interlinked file E may be managed by the cloud managing unit 300 of the second terminal 20. In addition, by manipulating the cloud managing unit 300, the cloud file E may still be stored in the synchronization region 50 of the first cloud server CS1 without being deleted. Therefore, the corresponding second interlinked file E stored in the first terminal 10 may be not influenced by the deletion of the second interlinked file E from the second terminal 20.

According to exemplary embodiments of the present invention, when a cloud service is used by multiple terminals, even when an interlinked file to be synchronized is deleted in at one of the terminals due to the limited capacities of the respective terminal, it may be possible to maintain data corresponding to a cloud file stored in the cloud server and manage the cloud file as if the corresponding interlinked file is still present at the respective terminal. In addition, when an interlinked file to be synchronized is deleted due to a deficient capacity of the terminal, a corresponding cloud file may be preserved by managing the database of the cloud managing unit. Accordingly, the respective terminal may access the cloud file by using the above scenario, which may save the storage space at the terminal and enhance the efficiency in management.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for synchronizing a cloud service, comprising:
identifying a cloud application corresponding to a cloud file stored in a first cloud server;
modifying the cloud file using the identified cloud application; and
updating a corresponding interlinked file stored in a first terminal to reflect the modification of the cloud file.

2. The method of claim 1, wherein the modifying comprises at least one of updating, deleting, and changing of a cloud server hosting the cloud file.

3. The method of claim 1, wherein the cloud application is designated to access the cloud file according to a category of the cloud file.

4. The method of claim 1, wherein the interlinked file comprises at least one of a first extended data field for storing management information corresponding to the cloud file, a second extended data field for identifying a number of cloud applications corresponding to the cloud file, and a third extended data file for storing information associated with the respective cloud applications.

5. The method of claim 1, further comprising updating relationship information between the cloud file, a cloud server storing the cloud file, the interlinked file, and the cloud application.

6. The method of claim 1, wherein the interlinked file comprises a portion of the cloud file, or information associated with the cloud file.

7. The method of claim 1, wherein the cloud application corresponding to the cloud server storing the cloud file is identified using a cloud managing application, the cloud managing application comprising relationship information of the cloud file and the cloud application.

8. The method of claim 1, further comprising:
retaining a backup file corresponding to the interlinked file after the interlinked file is deleted,
wherein the backup file provides access to the cloud file.

9. The method of claim 1, wherein, when the cloud file is shifted from a first cloud server to a second cloud server, the corresponding interlinked file is updated in the first terminal and the cloud application is updated to correspond to the second server.

10. A terminal to synchronize a cloud service, comprising:
a cloud application to access a cloud file stored in a first cloud server; and
a cloud managing unit to identify the cloud application to be synchronized with the cloud file, and when the cloud file is modified, to update a corresponding interlinked file stored in the first terminal to reflect the modification of the cloud file.

11. The terminal of claim 10, wherein modification comprises at least one of updating, deleting, and changing of a cloud server hosting the cloud file.

12. The terminal of claim 10, wherein the cloud application is designated to access the cloud file according to a category of the cloud file.

13. The terminal of claim 10, wherein the interlinked file comprises at least one of a first extended data field for storing management information corresponding to the cloud file, a second extended data field for identifying a number of cloud applications corresponding to the cloud file, and a third extended data file for storing information associated with the respective cloud applications.

14. The terminal of claim 10, wherein the cloud managing unit updates relationship information between the cloud file, a cloud server storing the cloud file, the interlinked file, and the cloud application.

15. The terminal of claim 10, wherein the interlinked file comprises a portion of the cloud file, or information associated with the cloud file.

16. The terminal of claim 10, wherein the cloud managing unit stores relationship information of the cloud file and the cloud application.

17. The terminal of claim 10, wherein the cloud application retains a backup file corresponding to the interlinked file after the interlinked file is deleted,
wherein the backup file provides access to the cloud file.

18. The terminal of claim 10, wherein, when the cloud file is shifted from a first cloud server to a second cloud server, the corresponding interlinked file is updated in the first terminal and the cloud application is updated to correspond to the second server.

19. The terminal of claim 10, further comprising an application managing unit comprising information associated with the cloud application.

20. A method for synchronizing a cloud service, comprising:
identifying a cloud application corresponding to a cloud file stored in a cloud server;
updating an interlinked file stored in a first terminal corresponding to the cloud file; and
updating the cloud file using the identified cloud application for reflecting the modification of the interlinked file.
